(19) United States
(12) Patent Application Publication
(10) Pub. No.: US 2025/0062556 A1
(43) Pub. Date: Feb. 20, 2025

(54) ELECTRICAL-CONNECTOR-EQUIPPED FLAT CABLE

(71) Applicant: Sumitomo Electric Industries, Ltd., Osaka (JP)

(72) Inventors: Tatsuo MATSUDA, Kanuma-shi (JP); Chiaki KOJIMA, Kanuma-shi (JP); Yasunori ASANO, Osaka-shi (JP)

(73) Assignee: Sumitomo Electric Industries, Ltd., Osaka (JP)

(21) Appl. No.: 18/790,045

(22) Filed: Jul. 31, 2024

(30) Foreign Application Priority Data
Aug. 14, 2023 (JP) 2023-131791

(51) Int. Cl. H01R 12/77; H01B 7/08

(52) U.S. Cl. CPC H01R 12/771; H01B 7/0861

(57) ABSTRACT

An electrical-connector-equipped flat cable includes a first flat cable including a first signal line and a first ground line, a first ferrule holding a first front end region, a second flat cable including a second signal line and a second ground line, a second ferrule holding a second front end region, and a shell disposed so as to surround the first ferrule and the second ferrule. The shell includes a frame body and a plate, the frame body being disposed outside the first ferrule and the second ferrule, the plate being disposed between the first ferrule and the second ferrule and electrically connected to the frame body. The plate includes a main body portion and a coupling portion electrically connected to each of the main body portion, the first ground line, and the second ground line.

### CROSS REFERENCE TO RELATED APPLICATIONS

The present application claims priority based on Japanese Patent Application No. 2023-131791, filed on Aug. 14, 2023, and the entire contents of the Japanese patent application are incorporated herein by reference.

### TECHNICAL FIELD

The present disclosure relates to an electrical-connector-equipped flat cable.

### BACKGROUND

An electrical connector including a cable having a plurality of signal lines and a plurality of ground lines, and a housing provided in a front end region of the cable is known (see, for example, WO 2019/208091).

### SUMMARY

An electrical-connector-equipped flat cable of the present disclosure includes a first flat cable including a first signal line and a first ground line, the first signal line being a conductor, the first ground line being a conductor, a first ferrule surrounding and holding a first front end region of the first flat cable, a second flat cable including a second signal line and a second ground line, the second signal line being a conductor, the second ground line being a conductor, a second ferrule surrounding and holding a second front end region of the second flat cable, and a shell disposed so as to surround the first ferrule and the second ferrule, the shell being made of metal. The shell includes a frame body and a plate. The frame body is disposed outside the first ferrule and the second ferrule. The plate is disposed between the first ferrule and the second ferrule, and electrically connected to the frame body. The plate includes a main body portion and a coupling portion. The main body portion is located between the first signal line and the second signal line. The coupling portion is electrically connected to each of the main body portion, the first ground line, and the second ground line.

### BRIEF DESCRIPTION OF THE DRAWINGS

FIG. 1 is a front view of an electrical-connector-equipped flat cable according to an embodiment.

FIG. 2 is a cross-sectional view of an electrical-connector-equipped flat cable taken along line II-II shown in FIG. 1.

FIG. 3 is a cross-sectional view of a flat cable taken along line III-III shown in FIG. 2.

FIG. 4 is a cross-sectional view of a flat cable and a dielectric constant adjusting sheet taken along line IV-IV shown in FIG. 2.

FIG. 5 is a partial enlarged view of the electrical-connector-equipped flat cable shown in FIG. 2.

FIG. 6 is a partial enlarged view of the electrical-connector-equipped flat cable shown in FIG. 2.

FIG. 7 is a front view of an electrical-connector-equipped flat cable according to a modification.

FIG. 8 is a schematic perspective view of a flat cable according to a modification.

### DETAILED DESCRIPTION

### Problems to be Solved by the Present Disclosure

The electrical connector described in WO 2019/208091 may include a plurality of cables adjacent to each other. In this case, noise is generated due to interference of signals of the cables. As a result, the communication performance of the electrical connector may be deteriorated.

### [Effects of the Present Disclosure]

According to the present disclosure, it is possible to provide an electrical-connector-equipped flat cable that can prevent the deterioration in the communication performance.

### Description of Embodiments of Present Disclosure

First, the contents of an embodiment of the present disclosure will be listed and explained.

An electrical-connector-equipped flat cable of the present disclosure is (1) “an electrical-connector-equipped flat cable including a first flat cable including a first signal line and a first ground line, the first signal line being a conductor, the first ground line being a conductor, a first ferrule surrounding and holding a first front end region of the first flat cable, a second flat cable including a second signal line and a second ground line, the second signal line being a conductor, the second ground line being a conductor, a second ferrule surrounding and holding a second front end region of the second flat cable, and a shell disposed so as to surround the first ferrule and the second ferrule, the shell being made of metal, wherein the shell includes a frame body and a plate, the frame body being disposed outside the first ferrule and the second ferrule, the plate being disposed between the first ferrule and the second ferrule and electrically connected to the frame body, and the plate includes a main body portion and a coupling portion, the main body portion being located between the first signal line and the second signal line, the coupling portion being electrically connected to each of the main body portion, the first ground line, and the second ground line”.

In the electrical-connector-equipped flat cable according to the above (1), the main body portion is disposed between the first signal line of the first flat cable and the second signal line of the second flat cable, and the first ground line of the first flat cable and the second ground line of the second flat cable are electrically connected to the main body portion via the coupling portion. Thus, when the shell is electrically connected to a ground, the ground potential of the vicinity of the first signal line of the first flat cable and the ground potential of the vicinity of the second signal line of the second flat cable are made common, and thus noise caused by interference of signals between the first signal line and the second signal line is reduced. Thus, according to the electrical-connector-equipped flat cable, it is possible to prevents the deterioration in the communication performance.

The electrical-connector-equipped flat cable of the present disclosure may be (2) “the electrical-connector-equipped flat cable according to (1), wherein the coupling portion is provided at a front end of the main body portion, a front end surface of the first flat cable and a front end surface of the first ferrule are located on a substantially identical plane, the coupling portion is located inside the first ferrule with respect to the front end surface of the first ferrule, a front end surface of the second flat cable and a front end surface of the second ferrule are located on a substantially identical plane, and the coupling portion is located inside the second ferrule with respect to the front end surface of the second ferrule”. In this case, the front end surface of the first flat cable and the front end surface of the first ferrule are located on a substantially identical plane, and the front end surface of the second flat cable and the front end surface of the second ferrule are located on a substantially identical plane. Thus, the first flat cable and the second flat cable can be suitably connected to a mating connector by connecting the front end surface of the first ferrule and the front end surface of the second ferrule to the mating connector. Further, since the coupling portion is located inside the first ferrule with respect to the front end surface of the first ferrule and is located inside the second ferrule with respect to the front end surface of the second ferrule, the coupling portion is prevented from interfering with the connection of the electrical-connector-equipped flat cable to the mating connector.

The electrical-connector-equipped flat cable of the present disclosure may be (3) “the electrical-connector-equipped flat cable according to (1) or (2), further including a first dielectric constant adjusting sheet, and a second dielectric constant adjusting sheet, wherein the first flat cable further includes a first covering that covers the first signal line and the first ground line such that a front end region of the first signal line and a front end region of the first ground line are exposed from the first covering, the second flat cable further includes a second covering that covers the second signal line and the second ground line such that a front end region of the second signal line and a front end region of the second ground line are exposed from the second covering, the first dielectric constant adjusting sheet covers the front end region of the first signal line and the front end region of the first ground line, the second dielectric constant adjusting sheet covers the front end region of the second signal line and the front end region of the second ground line, and the coupling portion of the plate penetrates a portion of each of the first dielectric constant adjusting sheet and the second dielectric constant adjusting sheet, and is electrically connected to each of the first ground line and the second ground line”. In this case, the dielectric constant of the vicinity of the first signal line and the dielectric constant of the vicinity of the second signal line are suitably adjusted, and thus the communication performance of the electrical-connector-equipped flat cable is improved.

The electrical-connector-equipped flat cable of the present disclosure may be (4) “the electrical-connector-equipped flat cable according to (3), wherein the first dielectric constant adjusting sheet includes a pair of sheets that sandwich the first signal line and the first ground line therebetween, and the second dielectric constant adjusting sheet includes a pair of sheets that sandwich the second signal line and the second ground line therebetween”. In this case, the manufacturing of each of the first flat cable and the second flat cable becomes easier.

The electrical-connector-equipped flat cable of the present disclosure may be (5) “the electrical-connector-equipped flat cable according to (3) or (4), wherein the first covering includes a pair of sheets that sandwich the first signal line and the first ground line therebetween, and the second covering includes a pair of sheets that sandwich the second signal line and the second ground line therebetween”. In this case, impedance matching in the first front end region of the first flat cable and impedance matching in the second front end region of the second flat cable are facilitated.

The electrical-connector-equipped flat cable of the present disclosure may be (6) “the electrical-connector-equipped flat cable according to any one of (3) to (5), wherein the first dielectric constant adjusting sheet and the first covering in the first front end region of the first flat cable are surrounded by the first ferrule, and the second dielectric constant adjusting sheet and the second covering in the second front end region of the second flat cable are surrounded by the second ferrule”. In this case, the first dielectric constant adjusting sheet can be reliably held by the first ferrule, and the second dielectric constant adjusting sheet can be reliably held by the second ferrule.

The electrical-connector-equipped flat cable of the present disclosure may be (7) “the electrical-connector-equipped flat cable according to any one of (3) to (6), wherein the first covering of the first flat cable includes a first shield layer having conductivity, the second covering of the second flat cable includes a second shield layer having conductivity, and the first shield layer and the second shield layer are each electrically connected to the shell”. In this case, when the shell is electrically connected to the ground, the ground potential of the vicinity of the first signal line of the first flat cable and the ground potential of the vicinity the second signal line of the second flat cable are made common, and thus noise caused by interference of signals between the first signal line and the second signal line is reduced.

The electrical-connector-equipped flat cable of the present disclosure may be (8) “the electrical-connector-equipped flat cable according to any one of (1) to (7), wherein the first front end region of the first flat cable is bent inside the first ferrule, and the second front end region of the second flat cable is bent inside the second ferrule”. In this case, the degree of freedom of arrangement of the electrical-connector-equipped flat cable is improved.

### Details of Embodiments of Present Disclosure

Examples of an electrical-connector-equipped flat cable of the present disclosure will be described below with reference to the drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

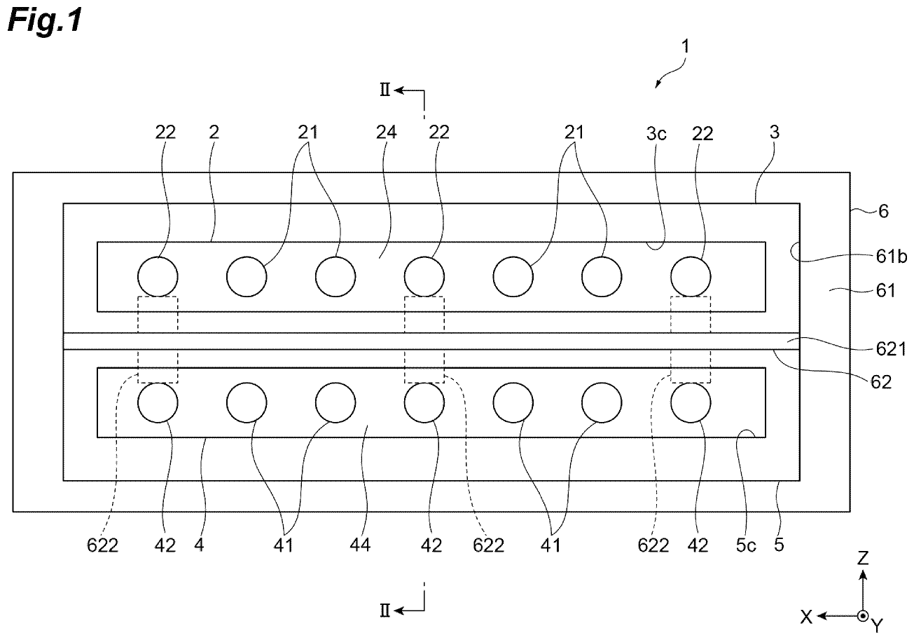

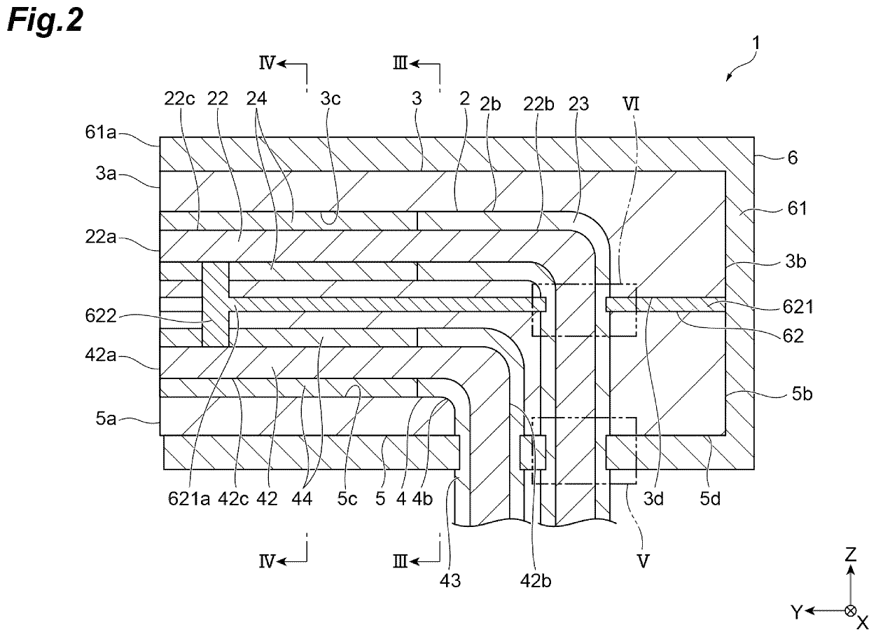

FIG. 1 is a front view of an electrical-connector-equipped flat cable of the embodiment. FIG. 2 is a cross-sectional view of the electrical-connector-equipped flat cable taken along line II-II shown in FIG. 1. As shown in FIGS. 1 and 2, an electrical-connector-equipped flat cable 1 includes a first flat cable 2, a first ferrule 3, a first dielectric constant adjusting sheet 24, a second flat cable 4, a second ferrule 5, a second dielectric constant adjusting sheet 44, and a shell 6.

First flat cable 2 is, for example, a flexible flat cable (FFC). First flat cable 2 includes a plurality of first signal lines 21, a plurality of first ground lines 22, and a first covering 23. First signal line 21 and first ground line 22 are conductors. First signal line 21 and first ground line 22 extend along the Y-axis direction. Each of first signal line 21 and first ground line 22 has, for example, a circular shape in a cross section along the XZ plane. The material of each of first signal line 21 and first ground line 22 is, for example, copper or a copper alloy. The arrangement of each of first signal line 21 and first ground line 22 is appropriately determined by the signal to be transmitted. In the embodiment, two first signal lines 21 are arranged side by side to transmit a differential signal. In the embodiment, first ground lines 22 are arranged on both sides of two first signal lines 21 (differential signal line pair).

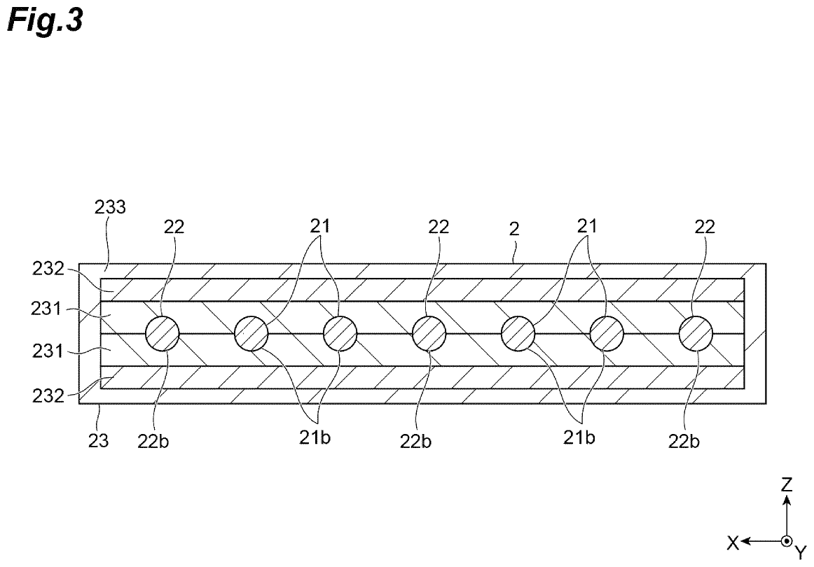

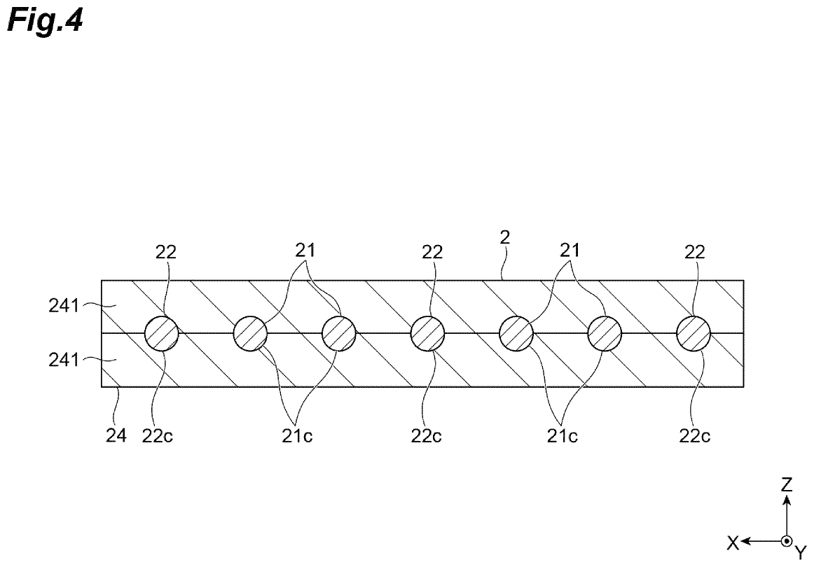

First covering 23 bundles the plurality of first signal lines 21 and the plurality of first ground lines 22. First covering 23 partially covers each of the plurality of first signal lines 21 and each of the plurality of first ground lines 22. Specifically, first ground line 22 includes a covered region 22b and a front end region 22c. Covered region 22b is covered with first covering 23. Front end region 22c is a region including a front end surface 22a of first ground line 22 in first ground line 22. Front end region 22c is exposed from first covering 23. Each of the plurality of first signal lines 21 includes a covered region 21b (see FIG. 3) covered with first covering 23 and a front end region 21c (see FIG. 4) exposed from first covering 23, similarly to first ground line 22.

First dielectric constant adjusting sheet 24 covers front end region 22c of each of the plurality of first ground lines 22. That is, first dielectric constant adjusting sheet 24 covers front end region 22c of first ground line 22, which is not covered with first covering 23. A region of first ground line 22 covered with first dielectric constant adjusting sheet 24 is front end region 22c. In the embodiment, the entire side surface of first ground line 22 is covered with first covering 23 and first dielectric constant adjusting sheet 24. Front end surface 22a of first ground line 22 is exposed from first dielectric constant adjusting sheet 24. In other words, front end surface 22a of first ground line 22 is not covered by first dielectric constant adjusting sheet 24. Front end region 21c (see FIG. 4) of each of the plurality of first signal lines 21 is covered with first dielectric constant adjusting sheet 24, similarly to front end region 22c of first ground line 22. The main component of first dielectric constant adjusting sheet 24 is, for example, polypropylene, or the like. The relative dielectric constant of first dielectric constant adjusting sheet 24 is equal to or greater than 0.9 times and equal to or less than 1.1 times the relative dielectric constant of first covering 23.

First ferrule 3 surrounds a first front end region 2b of first flat cable 2. Specifically, first ferrule 3 includes a front end surface 3a, a rear end surface 3b, a side surface 3d, and an insertion hole 3c. Each of front end surface 3a and rear end surface 3b is a flat surface intersecting with the Y-axis direction. Rear end surface 3b faces the opposite direction of front end surface 3a. Side surface 3d is one of the flat surfaces intersecting with the Z-axis direction. Insertion hole 3c is opened in each of front end surface 3a and side surface 3d. Insertion hole 3c is curved inside first ferrule 3. Insertion hole 3c includes a region that extends along the Y-axis direction and opens in front end surface 3a and a region that extends along the Z-axis direction and opens in side surface 3d.

First front end region 2b of first flat cable 2 is inserted into insertion hole 3c. In other words, a region of first flat cable 2 inserted into insertion hole 3c is first front end region 2b. In the embodiment, a region located between front end surface 3a and side surface 3d of first ferrule 3 in first flat cable 2 is first front end region 2b.

A front end surface of first signal line 21 and front end surface 22a of first ground line 22 are exposed from first ferrule 3. The front end surface of first signal line 21, front end surface 22a of first ground line 22, and front end surface 3a of first ferrule 3 are located on a substantially identical plane. The expression “substantially identical” includes not only “completely identical” but also “identical within a certain error range”. The certain error is, for example, about several micrometers. Each of the front end surface of first signal line 21 and front end surface 22a of first ground line 22 may protrude or recede from front end surface 3a of first ferrule 3 within a range in which each of first signal line 21 and first ground line 22 can be electrically connected to a conductor of a mating connector (receptacle). In the embodiment, for example, each of the front end surface of first signal line 21 and front end surface 22a of first ground line 22 protrudes from front end surface 3a of first ferrule 3. The portions of first signal line 21 and first ground line 22 protruding from front end surface 3a of first ferrule 3 may be electrically connected to the conductors of the mating connector in a state of being introduced into the inside of the mating connector when front end surface 3a of first ferrule 3 and the front end surface of the mating connector are in contact with each other.

First front end region 2b of first flat cable 2 is disposed inside insertion hole 3c in a state of being bent inside first ferrule 3. First dielectric constant adjusting sheet 24 in first front end region 2b of first flat cable 2 is surrounded by first ferrule 3. First covering 23 in first front end region 2b of first flat cable 2 is surrounded by first ferrule 3. A boundary between first dielectric constant adjusting sheet 24 and first covering 23 is located inside first ferrule 3. In the embodiment, first flat cable 2 is bent at a position of first covering 23.

First ferrule 3 holds first front end region 2b of first flat cable 2. First ferrule 3 is less likely to be deformed than first flat cable 2. The rigidity of first ferrule 3 is larger than the rigidity of first flat cable 2. First ferrule 3 contains, for example, polyetherimide (PEI), polyphenylene sulfide (PPS), polycarbonate (PC), polymethyl methacrylate (PMMA), polyethersulfone (PES) or the like as a main component.

Second flat cable 4 is disposed adjacent to first flat cable 2 in the Z-axis direction. The configuration of second flat cable 4 is the same as the configuration of first flat cable 2. Second flat cable 4 includes a plurality of second signal lines 41, a plurality of second ground lines 42, a second covering 43, and second dielectric constant adjusting sheet 44.

The configuration of second signal line 41 is the same as the configuration of first signal line 21. Second signal line 41 overlaps first signal line 21 when viewed from the Z-axis direction. The configuration of second ground line 42 is the same as the configuration of first ground line 22. Second ground line 42 overlaps first ground line 22 when viewed from the Z-axis direction.

The configuration of second covering 43 is the same as the configuration of first covering 23. Second covering 43 bundles the plurality of second signal lines 41 and the plurality of second ground lines 42. Second covering 43 covers a covered region 42b of each of second ground lines 42 and a covered region of each of second signal lines 41. A front end region 42c of each of second ground lines 42 and a front end region of each of second signal lines 41 are exposed from second covering 43.

The configuration of second dielectric constant adjusting sheet 44 is the same as the configuration of first dielectric constant adjusting sheet 24. Second dielectric constant adjusting sheet 44 covers front end region 42c of each of second ground lines 42 and the front end region of each of second signal lines 41.

The configuration of second ferrule 5 is the same as the configuration of first ferrule 3. Second ferrule 5 surrounds a second front end region 4b of second flat cable 4. Specifically, second ferrule 5 includes a front end surface 5a, a rear end surface 5b, a side surface 5d, and an insertion hole 5c. Second front end region 4b of second flat cable 4 is inserted into insertion hole 5c.

A front end surface of second signal line 41 and a front end surface 42a of second ground line 42 are exposed from second ferrule 5. The front end surface of second signal line 41, front end surface 42a of second ground line 42, and front end surface 5a of second ferrule 5 are located on a substantially identical plane. Second front end region 4b of second flat cable 4 is disposed inside insertion hole 5c in a state of being bent inside second ferrule 5. Second dielectric constant adjusting sheet 44 and second covering 43 in second front end region 4b of second flat cable 4 are surrounded by second ferrule 5. Second ferrule 5 holds second front end region 4b of second flat cable 4.

Shell 6 is made of metal. Shell 6 is disposed so as to surround first ferrule 3 and second ferrule 5. Specifically, shell 6 includes a housing 61 and a plate 62.

Housing 61 has, for example, a box shape having an opening. The opening of housing 61 is formed in a front end surface 61a. Housing 61 is disposed outside first ferrule 3 and second ferrule 5. In other words, first ferrule 3 and second ferrule 5 are accommodated in an internal space of housing 61. Each of front end surface 3a of first ferrule 3 and front end surface 5a of second ferrule 5 is located on a substantially identical plane with front end surface 6a of housing 61. Housing 61 is made of metal having conductivity.

Plate 62 is disposed between first ferrule 3 and second ferrule 5. Plate 62 is made of metal having conductivity. Plate 62 includes a main body portion 621 and a plurality of coupling portions 622. Main body portion 621 is located at least between the plurality of first signal lines 21 and the plurality of second signal lines 41. Both ends of main body portion 621 in the X-axis direction and a rear end of main body portion 621 in the Y-axis direction are each in contact with housing 61. Thus, main body portion 621 is electrically connected to housing 61.

Each of coupling portions 622 is located between first ground line 22 and second ground line 42. Coupling portion 622 is provided at a front end 621a of main body portion 621 in the Y-axis direction. Both ends of coupling portion 622 in the Z-axis direction protrude from main body portion 621. Coupling portion 622 has, for example, a rod shape. Each of coupling portions 622 is located inside first ferrule 3 with respect to front end surface 3a of first ferrule 3, and is located inside second ferrule 5 with respect to front end surface 5a of second ferrule 5. This prevents coupling portion 622 from interfering with the connection of electrical-connector-equipped flat cable 1 to the mating connector.

Each of coupling portions 622 is electrically connected to main body portion 621. Each of coupling portions 622 is integrally formed of the same material as main body portion 621. Coupling portion 622 penetrates a portion of first dielectric constant adjusting sheet 24 and is in contact with first ground line 22. Thus, coupling portion 622 is electrically connected to first ground line 22. Coupling portion 622 penetrates a portion of second dielectric constant adjusting sheet 44 and is in contact with second ground line 42. Thus, coupling portion 622 is electrically connected to second ground line 42.

A predetermined region of shell 6 is connected to a ground electrode of the mating connector. Thus, shell 6 is grounded. As a result, the ground potential of the vicinity of a pair of first signal line 21 and the ground potential of the vicinity of a pair of second signal line 41 are made common.

FIG. 3 is a cross-sectional view of first flat cable 2 taken along line III-III shown in FIG. 2. As shown in FIG. 3, first covering 23 includes a pair of insulating layers 231, a pair of shield layers 232, and a protection layer 233. The plurality of first signal lines 21 and the plurality of first ground lines 22 are disposed between the pair of insulating layers 231. The pair of insulating layers 231 sandwich the plurality of first signal lines 21 and the plurality of first ground lines 22 in the Z-axis direction. The material of insulating layer 231 is, for example, resin or the like. As the material of insulating layer 231, for example, resin having a relatively low relative dielectric constant and a relatively low dielectric loss tangent is used. The material of insulating layer 231 is, for example, polyethylene or polypropylene, or the like. Insulating layer 231 may have a laminated structure formed of a plurality of layers, for example. The pair of insulating layers 231 are bonded to each other, for example, with an adhesive.

The pair of shield layers 232 are disposed opposite to the plurality of first signal lines 21 and the plurality of first ground lines 22 with respect to the pair of insulating layer 231. The pair of shield layers 232 sandwich the pair of insulating layers 231 in the Z-axis direction. Shield layer 232 has conductivity. The material of shield layer 232 is, for example, metal or the like. The material of shield layer 232 is, for example, copper, aluminum, or the like. The thickness of shield layer 232 is, for example, equal to or greater than 5 μm and equal to or less than 20 μm. Shield layer 232 is bonded to insulating layer 231 with, for example, an adhesive.

Protection layer 233 is provided outside the pair of shield layer 232. Protection layer 233 surrounds the pair of insulating layers 231 and the pair of shield layers 232 when viewed from the Y-axis direction. Protection layer 233 covers a main surface of each of the pair of shield layers 232, side surfaces of each of the pair of shield layers 232, and side surfaces of each of the pair of insulating layers 231. This prevents contact of shield layer 232 with other metal members. As the material of protection layer 233, for example, resin or the like having excellent mechanical strength is used. The material of protection layer 233 is, for example, polyester (PEs) or polyethylene terephthalate (PET), or the like. Protection layer 233 is adhered to the pair of shield layers 232 and the pair of insulating layers 231, for example, with an adhesive. Second covering 43 also has a pair of insulating layers, a pair of shield layers, and a protection layer, similarly to first covering 23.

FIG. 4 is a cross-sectional view of first flat cable 2 and first dielectric constant adjusting sheet 24 taken along line IV-IV shown in FIG. 2. As shown in FIG. 4, first dielectric constant adjusting sheet 24 has a pair of sheets 241. The plurality of first signal lines 21 and the plurality of first ground lines 22 are disposed between a pair of sheets 241. The pair of sheets 241 sandwich front end region 21c of each of first signal lines 21 and front end region 22c of each of first ground lines 22 in the Z-axis direction. Second dielectric constant adjusting sheet 44 also has a pair of sheets that sandwich the front end region of each second signal line 41 and front end region 42c of each second ground line 42, similarly to first dielectric constant adjusting sheet 24.

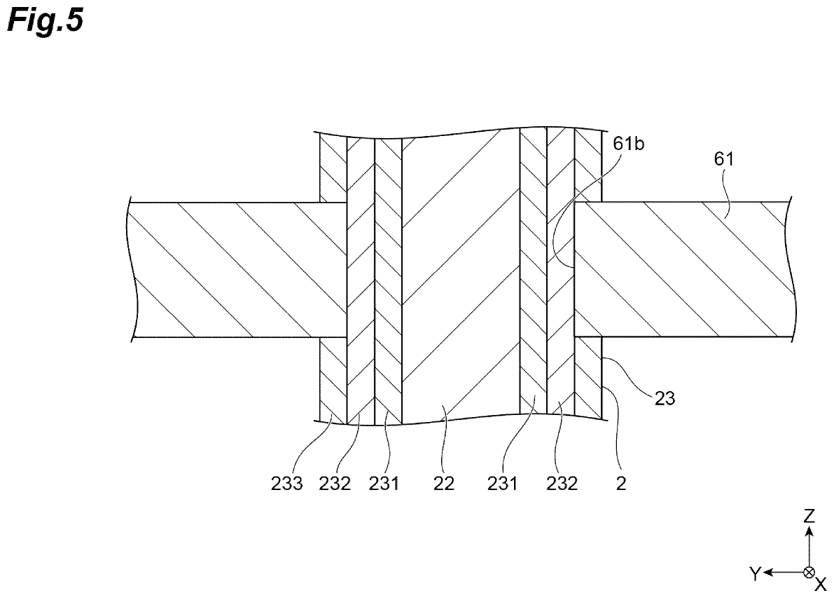

FIG. 5 is a partial enlarged view of a V portion of the electrical-connector-equipped flat cable shown in FIG. 2. As shown in FIG. 5, shield layer 232 of first flat cable 2 is electrically connected to housing 61 of shell 6. Specifically, housing 61 includes a through hole 61b. First flat cable 2 extends to the outside of housing 61 through through hole 61b. An inner surface of through hole 61b of housing 61 penetrates protection layer 233 of first flat cable 2 and is in contact with shield layer 232. The shield layer of second flat cable 4 is also electrically connected to housing 61 of shell 6, similarly to shield layer 232.

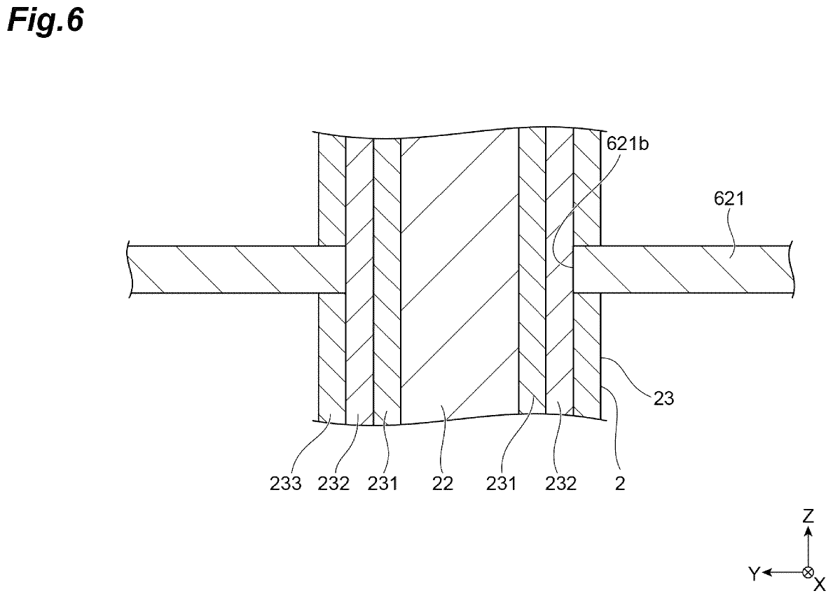

FIG. 6 is a partial enlarged view of a portion VI of the electrical-connector-equipped flat cable shown in FIG. 2. As shown in FIG. 6, shield layer 232 of first flat cable 2 is electrically connected to main body portion 621 of shell 6. Specifically, main body portion 621 includes a through hole 621b. First flat cable 2 extends to the outside of housing 61 through through hole 621b. An inner surface of through hole 621b of main body portion 621 penetrates protection layer 233 of first flat cable 2 and is in contact with shield layer 232. With this configuration, first ground line 22, second ground line 42, shield layer 232 of first covering 23, and the shield layer of second covering 43 are electrically connected to shell 6.

As described above, in electrical-connector-equipped flat cable 1, the ground potential of the vicinity of first signal line 21 of first flat cable 2 and the ground potential of the vicinity of second signal line 41 of second flat cable 4 are made common, and thus noise caused by interference of signals between first signal line 21 and second signal line 41 is reduced. Thus, according to electrical-connector-equipped flat cable 1, it is possible to prevent the deterioration in the communication performance.

A front end surface 2a of first flat cable 2 and front end surface 3a of first ferrule 3 are located on a substantially identical plane. A front end surface 4a of second flat cable 4 and front end surface 5a of second ferrule 5 are located on substantially identical plane. Thus, front end surface 3a of first ferrule 3 and front end surface 5a of second ferrule 5 are connected to the mating connector, and thereby first flat cable 2 and second flat cable 4 can be suitably connected to the mating connector. Coupling portion 622 provided at the front end 621a of main body portion 621 is located inside first ferrule 3 with respect to front end surface 3a of first ferrule 3, and is located inside second ferrule 5 with respect to front end surface 5a of second ferrule 5. This prevents coupling portion 622 from interfering with the connection of electrical-connector-equipped flat cable 1 to the mating connector. Further, for example, in a configuration in which upper surface portions of a plurality of conductors are exposed in a tip portion of a cable, and wiring portions are in contact with the upper surface portions of the conductors from above, thereby electrically connecting the wirings and the conductors, portions of signals propagating through the conductors may be branched at connection points between the upper surface portions of the conductors and the wiring portions and propagate to end surfaces of the conductors. In this case, transmission loss may increase due to the influence of reflection or the like of signals on the end surfaces of the conductors. In the embodiment, the front end surface of first signal line 21 is exposed from front end surface 3a of first ferrule 3, and the front end surface of second signal line 41 is exposed from front end surface 5a of second ferrule 5. Thus, the front end surface of first signal line 21 and the front end surface of second signal line 41 can be electrically connected to the mating connector, and the stab is prevented as compared with the case where first signal line 21 is electrically connected to the mating connector via a conductive body electrically connected to a side surface of front end region 21c or the case where second signal line 41 is electrically connected to the mating connector via a conductive body electrically connected to a side surface of the front end region 41c, for example.

Since the dielectric constant of the vicinity of first signal line 21 and the dielectric constant of the vicinity of second signal line 41 are suitably adjusted by first dielectric constant adjusting sheet 24 and second dielectric constant adjusting sheet 44, respectively, impedance is matched at the portion of first flat cable 2 attached to first ferrule 3 and the portion of second flat cable 4 attached to second ferrule 5, and as a result, the communication performance of electrical-connector-equipped flat cable 1 is improved.

First dielectric constant adjusting sheet 24 includes a pair of sheets 241 that sandwich first signal line 21 and first ground line 22 therebetween. Second dielectric constant adjusting sheet 44 includes a pair of sheets that sandwich second signal line 41 and second ground line 42 therebetween. Thus, the manufacturing of each of first flat cable 2 and second flat cable 4 becomes easier.

First covering 23 includes a pair of sheets (a pair of insulating layers 231 and a pair of shield layers 232) that sandwich first signal line 21 and first ground line 22 therebetween. Second covering 43 includes a pair of sheets that sandwich second signal line 41 and second ground line 42 therebetween. Thus, the manufacturing of each of first flat cable 2 and second flat cable 4 becomes easier. In addition, impedance matching in first front end region 2b of first flat cable 2 and impedance matching in second front end region 4b of second flat cable 4 are facilitated.

First dielectric constant adjusting sheet 24 and first covering 23 in first front end region 2b of first flat cable 2 are surrounded by first ferrule 3. Second dielectric constant adjusting sheet 44 and second covering 43 in second front end region 4b of second flat cable 4 are surrounded by second ferrule 5. Thus, first dielectric constant adjusting sheet 24 can be reliably held by first ferrule 3, and second dielectric constant adjusting sheet 44 can be reliably held by second ferrule 5.

First front end region 2b of first flat cable 2 is bent inside first ferrule 3, and second front end region 4b of second flat cable 4 is bent inside second ferrule 5. This improves the degree of freedom in the arrangement of electrical-connector-equipped flat cable 1.

Each of shield layer 232 of first covering 23 of first flat cable 2 and the shield layer of the second covering of second flat cable 4 are electrically connected to shell 6. Thus, when shell 6 is electrically connected to a ground, the ground potential of the vicinity of first signal line 21 of first flat cable 2 and the ground potential of the vicinity of second signal line 41 of second flat cable 4 are made common, and thus noise caused by signal interference between first signal line 21 and second signal line 41 is reduced.

### [Modification]

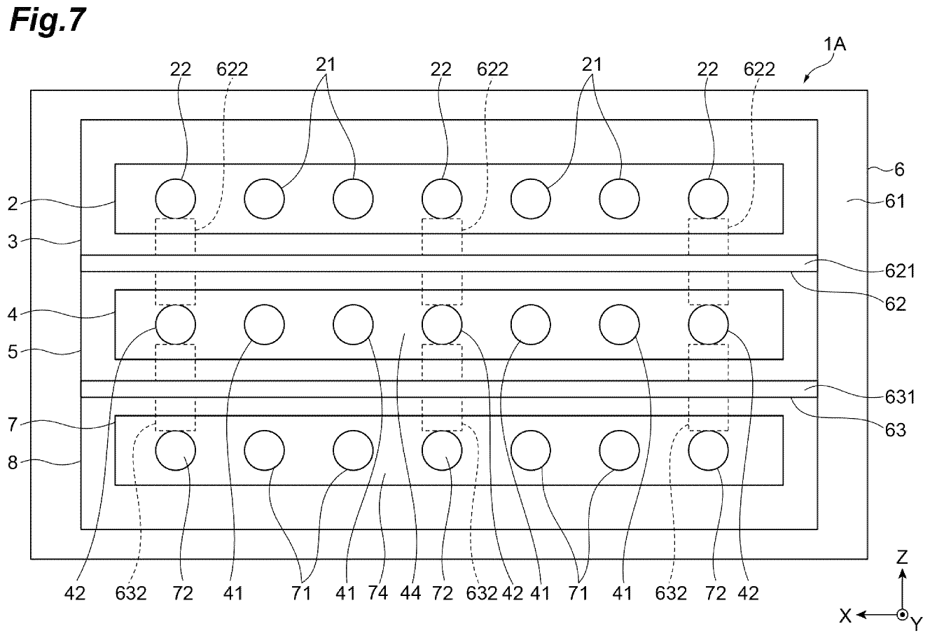

FIG. 7 is a front view of an electrical-connector-equipped flat cable according to a modification. As shown in FIG. 7, an electrical-connector-equipped flat cable 1A according to the modification may further include a third flat cable 7, a third ferrule 8, and a third dielectric constant adjusting sheet 74. In this case, electrical-connector-equipped flat cable 1A further includes a plate 63 in addition to plate 62. The configuration of third flat cable 7 is the same as the configuration of first flat cable 2. Third flat cable 7 includes a plurality of third signal lines 71, a plurality of third ground lines 72, and a third covering. The configuration of third ferrule 8 is the same as the configuration of first ferrule 3. The configuration of plate 63 is the same as the configuration of plate 62. Plate 63 is disposed between second ferrule 5 and third ferrule 8. Plate 63 includes a main body portion 631 and a plurality of coupling portions 632. Main body portion 631 is electrically connected to housing 61. Coupling portion 632 is electrically connected to main body portion 631, second ground line 42 of second flat cable 4, and third ground line 72 of third flat cable 7. An electrical-connector-equipped flat cable may include four or more flat cables.

Each of first covering 23 and second covering 43 may be integrally formed by, for example, extrusion molding.

Each of first front end region 2b of first flat cable 2 and second front end region 4b of second flat cable 4 does not have to be bent. In this case, insertion hole 3c may extend along the Y-axis direction and may be opened to each of front end surface 3a and rear end surface 3b of first ferrule 3, and insertion hole 5c may extend along the Y-axis direction and may be opened to each of front end surface 5a and rear end surface 5b of second ferrule 5.

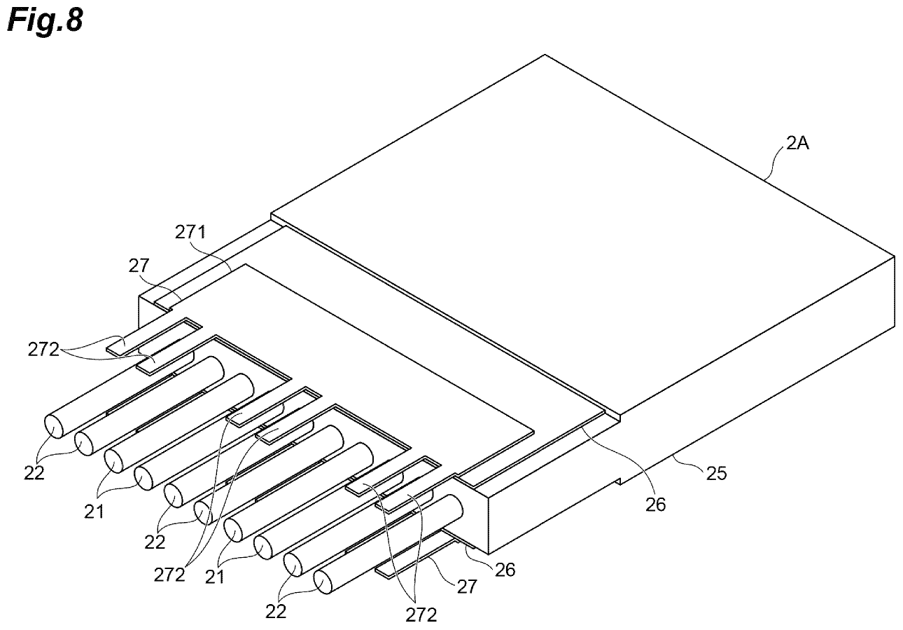

FIG. 8 is a schematic perspective view of first flat cable 2 according to the modification. As shown in FIG. 8, a flat cable 2A according to the modification is different from first flat cable 2 mainly in that flat cable 2A has a protection layer 25, shield layers 26, and ground bars 27. Protection layer 25 covers shield layers 26, but does not cover shield layers 26 at an end of flat cable 2A, and shield layers 26 are exposed from protection layer 25. Shield layers 26 extend over the entire length of flat cable 2A, but are exposed from protection layer 25 on both surfaces of the end (the upper surface and the lower surface (not shown) in FIG. 8). Shield layer 26 has conductivity similarly to shield layer 232.

Ground bar 27 is provided on a front surface of each of shield layers 26. Ground bar 27 has conductivity. Ground bar 27 includes a main body region 271 and a plurality of coupling regions 272. Main body region 271 overlaps with the front surface of shield layer 26. The plurality of coupling regions 272 protrude from main body region 271. Each of coupling regions 272 overlaps with corresponding first ground line 22 when viewed from a thickness direction of flat cable 2A. Coupling regions 272 are electrically connected to first ground line 22. Thus, shield layer 26 is electrically connected to shell 6 via ground bars 27 and each first ground line 22. In this case, shield layer 26 does not have to be directly connected to (in contact with) shell 6 as shown in FIG. 5 or 6. Second flat cable 4 may be configured similarly to flat cable 2A according to the modification.

What is claimed is:

1. An electrical-connector-equipped flat cable comprising:
a first flat cable including a first signal line and a first ground line, the first signal line being a conductor, the first ground line being a conductor;
a first ferrule surrounding and holding a first front end region of the first flat cable;
a second flat cable including a second signal line and a second ground line, the second signal line being a conductor, the second ground line being a conductor;
a second ferrule surrounding and holding a second front end region of the second flat cable; and
a shell disposed so as to surround the first ferrule and the second ferrule, the shell being made of metal, wherein
the shell includes a frame body and a plate, the frame body being disposed outside the first ferrule and the second ferrule, the plate being disposed between the first ferrule and the second ferrule and electrically connected to the frame body, and
the plate includes a main body portion and a coupling portion, the main body portion being located between the first signal line and the second signal line, the coupling portion being electrically connected to each of the main body portion, the first ground line, and the second ground line.

2. The electrical-connector-equipped flat cable according to claim 1, wherein
the coupling portion is provided at a front end of the main body portion,
a front end surface of the first flat cable and a front end surface of the first ferrule are located on a substantially identical plane,
the coupling portion is located inside the first ferrule with respect to the front end surface of the first ferrule,
a front end surface of the second flat cable and a front end surface of the second ferrule are located on a substantially identical plane, and
the coupling portion is located inside the second ferrule with respect to the front end surface of the second ferrule.

3. The electrical-connector-equipped flat cable according to claim 1, further comprising:
a first dielectric constant adjusting sheet; and
a second dielectric constant adjusting sheet, wherein
the first flat cable further includes a first covering that covers the first signal line and the first ground line such that a front end region of the first signal line and a front end region of the first ground line are exposed from the first covering,
the second flat cable further includes a second covering that covers the second signal line and the second ground line such that a front end region of the second signal line and a front end region of the second ground line are exposed from the second covering,
the first dielectric constant adjusting sheet covers the front end region of the first signal line and the front end region of the first ground line,
the second dielectric constant adjusting sheet covers the front end region of the second signal line and the front end region of the second ground line, and
the coupling portion of the plate penetrates a portion of each of the first dielectric constant adjusting sheet and the second dielectric constant adjusting sheet, and is electrically connected to each of the first ground line and the second ground line.

4. The electrical-connector-equipped flat cable according to claim 3, wherein
the first dielectric constant adjusting sheet includes a pair of sheets that sandwich the first signal line and the first ground line therebetween, and
the second dielectric constant adjusting sheet includes a pair of sheets that sandwich the second signal line and the second ground line therebetween.

5. The electrical-connector-equipped flat cable according to claim 3, wherein
the first covering includes a pair of sheets that sandwich the first signal line and the first ground line therebetween, and
the second covering includes a pair of sheets that sandwich the second signal line and the second ground line therebetween.

6. The electrical-connector-equipped flat cable according to claim 3, wherein
the first dielectric constant adjusting sheet and the first covering in the first front end region of the first flat cable are surrounded by the first ferrule, and
the second dielectric constant adjusting sheet and the second covering in the second front end region of the second flat cable are surrounded by the second ferrule.

7. The electrical-connector-equipped flat cable according to claim 3, wherein
the first covering of the first flat cable includes a first shield layer having conductivity,
the second covering of the second flat cable includes a second shield layer having conductivity, and
the first shield layer and the second shield layer are each electrically connected to the shell.

8. The electrical-connector-equipped flat cable according to claim 1, wherein
the first front end region of the first flat cable is bent inside the first ferrule, and
the second front end region of the second flat cable is bent inside the second ferrule.
